(19) United States
(12) Patent Application Publication
(10) Pub. No.: US 2023/0407851 A1
(43) Pub. Date: Dec. 21, 2023

(54) PROPULSION UNIT FOR SPACECRAFT

(71) Applicants: NEUTRONSTAR SYSTEMS UG, KÖLN (DE); UNIVERSITÄT STUTTGART, STUTTGART (DE)

(72) Inventors: MARCUS COLLIER-WRIGHT, KÖLN (DE); MANUEL LA ROSA BETANCOURT, KÖLN (DE); NANTWIN GERHARD KUHN, KÖLN (DE); GEORG HERDRICH, KÖLN (DE)

(21) Appl. No.: 18/035,193

(22) PCT Filed: Nov. 3, 2021
(86) PCT No.: PCT/EP2021/080513

§ 371 Date: May 3, 2023

(30) Foreign Application Priority Data
Nov. 3, 2020 (DE) 102020128964.2
Nov. 11, 2020 (GB) 2017811.7

(51) Int. Cl. F03H 1/00; B64G 1/40

(52) U.S. Cl. CPC F03H 1/0081; B64G 1/413; F03H 1/0031

(57) ABSTRACT

A propulsion unit (10) for a spacecraft is described. The propulsion unit (10) comprises a centrally arranged cathode (20), a concentric anode (30), an injection point (60) for injecting a propellant (50) between the central cathode (20) and the concentric anode (30), an acceleration coil system (100) and a vectoring coil system (110) for expelling a plasma plume (75) from a nozzle (115). A plurality of superconducting coils (120, 125) is arranged about the concentric anode (30) for creating a magnetic field (B) between the central cathode (20) and the concentric anode (30) and directing the plasma plume (65) from the nozzle (115).

### CROSS-REFERENCE TO RELATED APPLICATIONS

This application claims priority of German Patent Application number 10 2020 128 964.2, filed on 3 Nov. 2020 and the British Patent Application number 2017811.7, filed on 11 Nov. 2020. The entire disclosure of the German Patent Application number 10 2020 128 964.2 and the British Patent Application number 2017811.7 is hereby incorporated herein by reference

### FIELD OF THE INVENTION

The field of the invention relates to a propulsion system for a spacecraft

### BACKGROUND OF THE INVENTION

A magnetoplasmadynamic (MPD) thruster (MPDT) is a form of electrically powered spacecraft propulsion which uses the Lorentz force to generate thrust. The Lorentz force is the force exerted on a charged particle by an electromagnetic field. The magnetoplasmadynamic is sometimes referred to as a Lorentz Force Accelerator (LFA), a central-cathode electrostatic thruster or an MPD “arcjet”.

The MPDT works by feeding gaseous material into an acceleration chamber, where the gaseous material is ionized to form a plasma. The magnetic and electrical fields in the acceleration chamber are created using a power source. The ionized particles in the plasma are then propelled by the Lorentz force resulting from the interaction between the current flowing through the plasma and the magnetic field out through the exhaust chamber. Unlike chemical propulsion, there is no combustion of fuel. As with other electric propulsion variations, both specific impulse and thrust increase with power input, while thrust per watt drops.

There are two main types of MPD thrusters, applied-field and self-field. The applied-field MPD thrusters have magnetic coils surrounding the exhaust chamber to produce an additional magnetic field. The self-field MPD thrusters have a cathode extending through the middle of the exhaust chamber.

Various gaseous materials are used such as but not limited to xenon, neon, argon, hydrogen, hydrazine, ammonia, nitrogen, magnesium, methane, hydrogen/oxygen mixtures, and lithium have been used, with lithium generally being the best performer. Mixtures of the gaseous materials can also be used.

Electromagnetic propulsion systems for spacecraft are known in the art. For example, Japanese Patent No JP 5417643 B2 teaches a superconducting magnet device which can cool a superconducting coil for use in a propulsion device.

International patent application Nr. WO 2020/174378 (Zenno Astronautics) also teaches the use of a spacecraft with a superconducting magnet and a cooling element. A cryocooler is connected to the cooling element. The superconducting magnet is used in a propulsion system which enables the interaction of the spacecraft's own magnetic field with external magnetic fields, such as the sun's magnetic field or the earth's magnetic field for steering and propelling the spacecraft. The application does not teach the use of a superconducting magnet in a magnetoplasmadynamic thruster.

### SUMMARY OF THE INVENTION

This document describes a propulsion unit called an applied field magnetoplasmadynamic thruster with an electromagnet providing the applied field about an exhaust chamber. The electromagnet is constructed with a superconducting coil system made of superconductive material and can be used in a spacecraft, such as a satellite.

The propulsion unit includes a centrally arranged cathode and a concentric anode arranged about the cathode. An injection point for injecting a propellant is located between the central cathode and the concentric anode. The superconducting coil system comprises an acceleration coil system and a vectoring coil system for expelling a plasma plume from a nozzle. The direction of expulsion of the plasma plume can be varied by changing the direction of the flux in the magnetic fields and thus the direction of travel of the spacecraft can be varied. A plurality of superconducting coils is arranged about the concentric anode to create a magnetic field between the central cathode and the concentric anode.

The propulsion unit further comprising a thermal management system arranged between at least part of the concentric anode and the plurality of superconducting coils. The thermal management system manages the temperature within the propulsion unit and may include sensors to measure the temperature and pressure within the propulsion unit.

In one aspect, the propulsion unit comprises a cryostat for cooling the superconducting coils. In another aspect, the superconducting coils are cooled by radiative cooling

At least some of the plurality of superconducting coils are arranged in one of a triple helix or a double helix manner about the concentric anode. This arrangement enables change of the direction of the magnetic field.

This document also describes a method of propelling a spacecraft. The method comprises generating a plasma in a volume between a centrally arranged cathode and a concentric anode, generating a first magnetic field from a first superconducting magnet system in the volume to accelerate ions in the plasma and create a plasma plume, and generating a second magnetic field in the second superconducting magnet system, thereby causing the plasma plume to be directed in a movement direction.

### DESCRIPTION OF THE FIGURES

FIG. 1 shows an example of a magnetoplasmadynamic thruster 10.

FIG. 2A shows a double helix superconducting coil.

FIG. 2B shows direction of currents in the superconducting coils and resultant magnetic field.

FIG. 3 shows a triple helix coil

FIGS. 4 and 5 show design of an anode.

FIG. 6 is the power distribution for SX3 operating at 0.4 T and 60 mg/s for various discharge currents.

FIG. 7 is the maximum operation temperatures for different anode geometries for different molybdenum alloys

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

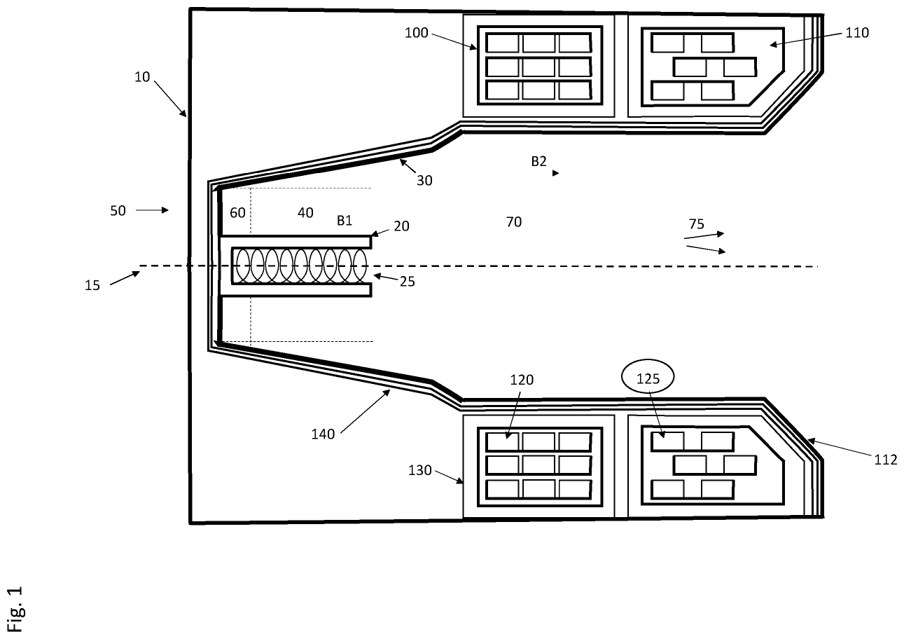

FIG. 1 shows an example of a magnetoplasmadynamic thruster 10 of this document. The magnetoplasmadynamic thruster 10 is used on a spacecraft and comprises two concentric electrodes, a cathode 20 and an anode 30. The cathode 20 and the anode 30 are both of a substantially cylindrical geometry. The design of the cathode 20 is of the hollow cathode variety and includes a thermionic insert 25 produced of lanthanum hexaboride. Other Materials can be used which are thermionic emitters and characterised by having a low work function e.g. Barium Oxide Scandate, Barium Oxide Tungsten, Molybdenum, Tantalum, Tungsten, Lanthanum Molybdenum, Calcium Aluminate, Cerium Hexaboride, Cermet, etc. Similar materials with relevant impregnates including but not limited to Barium Oxide, Calcium Oxide, Aluminium Oxide can be used. The two concentric electrodes (cathode 20 and anode 30) and the volume 40 between the cathode 20 and the anode 30 comprise collectively a discharge unit. The cathode 20 and the anode 30 have a common central axis 15. The use of the lanthanum hexaboride hollow cathode 20 extends the lifetime of the magnetoplasmadynamic thruster 10 by reducing the erosion rates associated with other types of cathode.

An electric voltage is supplied between the two electrodes 20 and 30. A propellant 50 in gaseous form is fed into this discharge unit, either with a single injection point 60, or with a split injection of the propellant between the cathode 20 and the anode 30 (not shown). The propellant 50 is ionised within the discharge unit, and an electric current flows from the anode 30 to the cathode 20 through the resulting plasma 70 formed from the ionised propellant.

Two superconducting magnet systems 100 and 110 are located outside of the discharge unit. The two superconducting magnet systems 100 and 110 comprise of a plurality of superconducting coils 120 within a cryostat 130. A thermal management system 140 is also provided between the superconducting coils 120 to reduce the amount of heat from the plasma 70 reaching the superconducting coils 120. The first superconducting magnet system 100 is used for providing a first magnetic field B1 which contributes to the acceleration of the plasma 70 through the interaction with the current between the cathode 20 and the anode 30, by means of a Lorentz Force, a Hall acceleration, a swirl acceleration, and a thermodynamic acceleration arising from the expansion of the hot gas and plasma within the discharge unit. The swirl acceleration arises from the swirling motion of the plasma 70 due to the presence of the applied magnetic field B. This first superconducting magnet system 110 is referred to as the acceleration coil system.

The superconducting coils 120 are constructed within the acceleration coil system 100 in such a way so as to provide the first magnetic field B1 acting in the direction of the thruster central axis 15. The superconducting coils 120 are produced of a rectangular cross section with a superconducting layer being formed of any type of superconductor. Examples of the superconductor include, but are not limited to, type 2G high-temperature superconductors (HTS) such as Yttrium Barium Copper Oxide, Lanthanum Barium Copper Oxide and other Rare-Earth Barium Copper Oxides, Magnesium Diboride, Bismuth Strontium Calcium Copper Oxide (Bi2223 or Bi2212). The use of very high-temperature superconductors, including those which require higher pressures for operation, and those which could be operated at room temperature, are also considered as potential materials.

The number and positioning of the individual first superconducting coils 120 within the cryostat 130 can be varied. Examples shown in the example of FIG. 1 are nine coils in a 3×3 configuration. It would be possible to use, for example, six coils in a 3×2 configuration, and three coils in a 3×1 configuration.

The second superconducting magnet system 110 is used to produce a magnetic field B2 nominally in the axial direction of the magnetoplasmadynamic thruster 10, but whose direction can be altered with a deflection of up to plus/minus 10 degrees in any direction about the thruster central axis, preferably up to plus/minus 20 degrees, preferably up to plus/minus 40 degrees, and most preferably up to plus/minus 60 degrees. Hence this second superconducting magnet system 110 is referred to as the vectoring coil system. The vectoring coil system also includes parts of the cryostat 130 and the thermal management system 140.

Within the vectoring coil system 110, the second superconducting coils 125 are constructed as solenoids whereby by altering the magnitude and direction of the current in each of the superconducting coils, the resulting direction of the magnetic field B2 can be adjusted in any of the three orthogonal directions to eject the ions in a plasma plume 75 at a required direction. An end 112 of the vectoring coil system 110 is shown as being at an angle and forms a nozzle. This nozzle enables the ion to be ejected at a required angle.

The superconducting coils 120 and 125 can be kept cool by a corresponding cryogenic system. Such a system uses cooling technologies such as, but not restricted to, Pulse Tube Tactical Cooling; Pulse Tube Miniature Tactical Cooling; Joule-Thompson Coolers; Reverse Turbo-Brayton Coolers; Stirling Cryocoolers; The coolers are connected with the coils and the coils are located within a cryostat which maintains the operational temperature for the coil operation. In an alternative aspect of the thruster system, the use of a radiatively cooled superconductors is envisaged as a possibility which do not require a cryogenic system. The superconducting coils in this aspect are loaded with electrical current either through a physical coil loading connection 150, such as, but not limited to ohmic current leads, joints, or connectors, or through a non-physical coil loading connection 150, such as, but not limited to, inductive loading through the use of a device such as a flux pump.

Between the discharge unit 10 and the first superconducting magnet system 100 and the second super conducting magnet system. 110 is located the thermal management system 140 which ensures that the superconductors can operate below their critical temperature (50K or less) in the presence of high temperatures at the plasma plume (2000K or more). Such a thermal management system 140 is comprised of several layers of insulation which form a multi-layer, multi-material architecture. A non-limiting example of such an architecture considers the use of a Caesium-infused Silicon Carbide as a first insulating layer, Mullite or a Titanium Alloy as the secondary insulating layer, and various Aerogels as further insulating layers. The thermal management system 140 operates principally through passive cooling and radiative/conductive thermal shielding.

The thermal management system 140 will contain embedded sensors which monitor the temperature and pressure within the system, in order to monitor the physical stability and condition of the system by monitoring the temperature gradient. Such sensors are connected with the thruster control software by means of telemetry in order to adjust operational parameters to respond to changes in detected values. Should, for example, the sensors detect a higher temperature (or an unexpected increase in temperature) in the thermal management system, this could imply that heat is being lost from the interior of the propulsion unit 10 and the efficiency of the propulsion unit 10 being reduced.

Sensors which can withstand the high temperatures are known. For example, sensors made of a silicon carbide allow which withstand temperatures up to 1600K can be used in the thermal management system 140.

The use of the superconducting coils as opposed to conventional coils reduces the mass and volume of the coil as well as the power required to initiate and maintain the magnetic fields B1 and B2. For the acceleration coil, the use of superconducting coils enables magnetic fields up to 2.0 T or higher (as opposed to 0.6 T for conventional technology) hence leading to an increase in thrust efficiency. The higher magnetic fields allow the discharge current to be reduced and the discharge voltage to be increased, resulting in increases in thruster lifetime through the reduction of electrode erosion rates. Furthermore, according to validated scaling laws the increase in magnetic field strength leads to a reduction in the ohmic losses at the anode, hence a reduction in the loss of energy of the thruster discharge, and an increase in thrust efficiency (as known from “Advanced Scaling Model for Simplified Thrust and Power Scaling of an Applied-Field Magnetoplasmadynamic Thruster”, Herdrich, G. H. et al. American Institute of Aeronautics and Astronautics. 46^{th} Joint Propulsion Conference, 25-28 Jul. 2010,Nashville (https//doi.org/10.2514/6.2010-6531).

For the second superconducting magnet system 120, i.e. the vectoring coil system, the deflection of the plasma plume 75 as a result of the applied magnetic field allows the vector of the thrust component produced by the thruster to be altered, which is a necessary capability of thrusters on the spacecraft vehicle. Currently this change of direction is achieved using a mechanical gimbal. The use of the superconducting coils enables the same functionality to be achieved with a greatly reduced mass and with no moving parts, hence improving system reliability and performance.

The design of the first superconducting coils 120 will now be explained. The use of a single superconducting coil in the acceleration coil system 100 enables the control of the magnitude (strength) of the magnetic field B1 but not the topology of the magnetic field B1 to be controlled in this area. There are areas of the discharge unit in which the plasma 70 is weakly ionised. These areas require a higher electron density to increase the degree of ionisation. In particular, large magnetic fields around the anode 30 create a low electron density area that reduces the conductivity and increases the anode fall voltage. The topology of the magnetic field B1 of the ring shape first superconducting coil 120 decreases fast as the distance from the coil centre is increased. The acceleration of the plasma happens only in the proximity of the discharge unit. By changing the configuration of the first superconducting coils, then areas of large magnetic field can be extended downstream and therefore increased the acceleration of the plasma in the discharge unit. The superconducting systems may be further used to generate electromagnetic fields in order to protect spacecraft components, systems, or passengers against cosmic radiation and other harmful phenomena in the space environment.

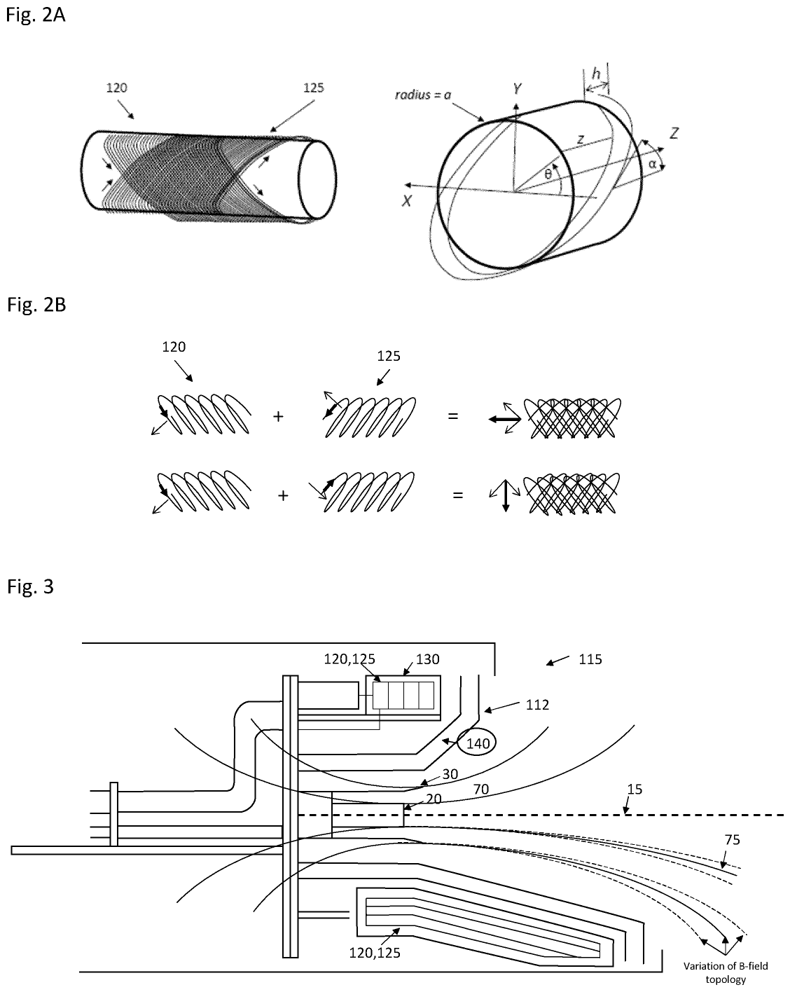

In one aspect, the first superconducting coils 120 and the second superconducting coils 123 are made of double helix coils, as shown in FIGS. 2A and 2B. This configuration enables the control of the topology of the magnetic field B1 to:
Maximise the degree of ionisation (single charge) in the acceleration coil system 100.
The acceleration of the plasma in a wide range of operational conditions.
Reduce the anode heat production; and
Change thrust vector in the vectoring coil system 110

FIG. 2A shows a superconductor magnet 200 with a double helix winding of two superconducting coils 210 and 220 with a common axis 230. Two different types of windings of the superconducting coils 210 and 220 re shown in FIG. 2B and lead to different topologies of the magnetic field depending on the direction of the electric current flowing in the superconducting coils 210 and 220. The smaller arrows on the superconducting coils 210 and 220 show the direction of the magnetic field and the larger arrow on the right-hand side of the figure shows the resultant magnetic field.

The use of a solenoid stretching over a longer area instead of a ring will increase the length of the region with high magnetic fluxes and therefore the size of the region in which the ions are accelerated. See, for example, Merton “Magnetic nozzles for electric propulsion”, EPIC lecture series, (2017), Madrid. Url: http://epic-src.eu/wp content/uploads/09_EPICLectureSeries2017_UC3M_nozzles-merino.pdf.

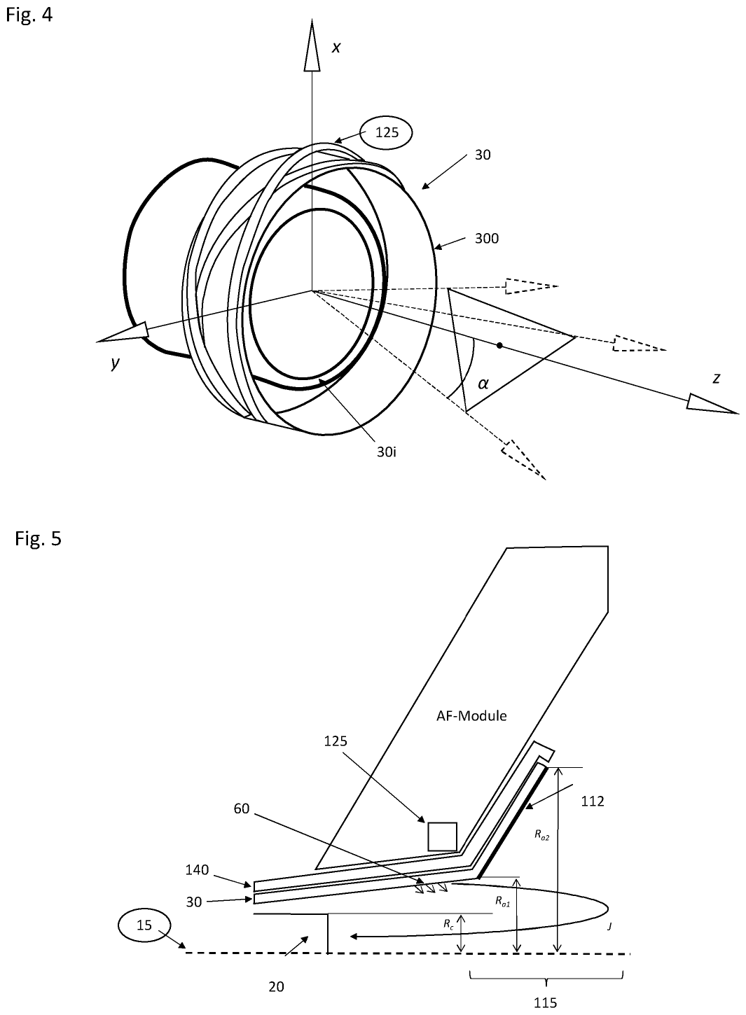

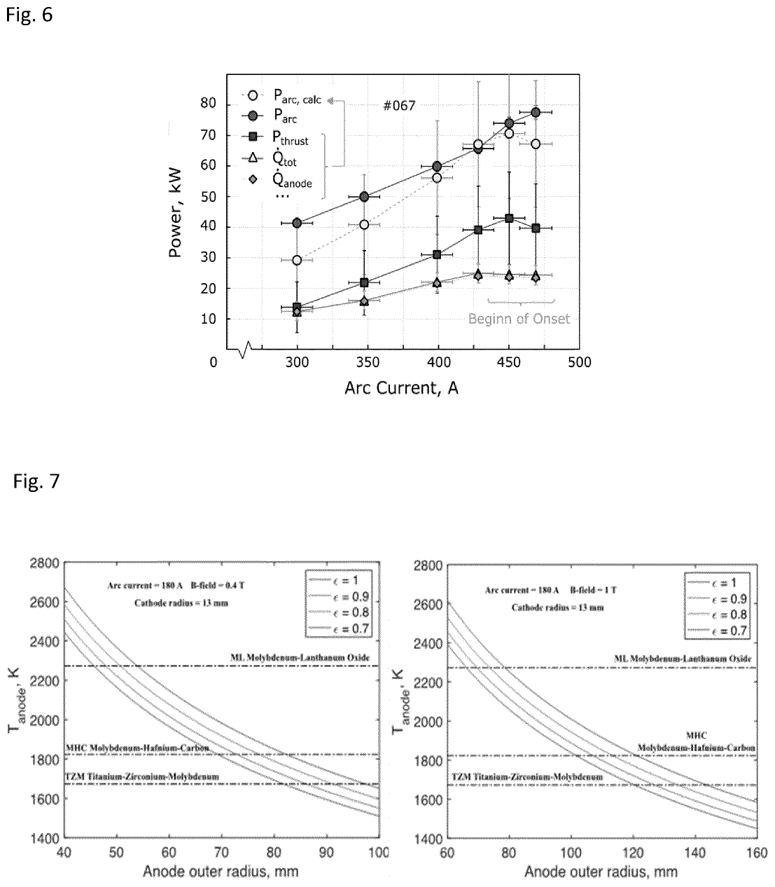

A further example of the first superconducting coils 320 and the second superconducting coils 325 is shown in FIG. 3 in which the magnetic field strength along the symmetry axis 330 generated by the conventional and the helix saddle coil configurations are shown. FIG. 3 shows a thruster 300 with a magnetic field strength along the symmetry axis 330 generated by the conventional (top) and the helix saddle (bottom) coil configurations. The use of three coils (i.e. a triple helix) enables the use of asymmetric magnetic field topologies to change the direction of the plasma plume 70 and use the same superconducting coils to accelerate and have a control of on the thrust vector as shown in FIG. 4 (adapted from M. Merino, Magnetic nozzles for electric propulsion, EPIC lecture series, (2017), Madrid. Url: http://epic-src.eu/wp content/uploads/09_EPICLectureSeries2017_UC3M_nozzles-merino.pdf).

The design of the anode 30 will now be discussed. The anode 30 is designed to minimise the heat losses, mainly coming from an increase of the anode fall voltage, and to increase the heat dissipation by thermal radiation in order to reduce the operational temperatures of the anode 30. The shape of the anode 30 is shown in FIG. 4 can be approximated to two conical segments, but the anode 30 is formed as a single piece. The inner piece 30i has a conducting surface and is where the arc attaches and there is an electric current flowing. The outer piece 30o has a high temperature coating with a high surface emissivity. No electric current is flowing in this outer piece and it is meant for increasing the heat dissipation through radiation.

The anode 30 is made of a high temperature alloy with moderate work function in order to reduce electron emission that will increase the anode voltage, with high surface emissivity and good electrical and thermal conductivity. In one non-limiting aspect, molybdenum alloys are foreseen to be used.

The anode 30 feature gas channels and orifices for the injection of gas within the area where the arc attaches and therefore reduce the anode fall voltage as shown in FIG. 5. The divergence angle of the inner conical section follows the magnetic field lines in order to minimise parasite currents within the anode. The outer section maximises the area for radiation and leaves room for the applied field (AF) module comprising the cryogenic system, superconducting coils, and the cryostat.

A small coil is placed behind the anode and near the arc attachment area in order to locally reduce the B-fields and minimise the anode fall voltage.

The anode material as well as the geometry of the nozzle 115 will be determined by the nominal and maximal operational conditions of the thruster 10 at a given mission. In order to estimate the maximal operational temperatures for the anode 40, the following points need to be taken into account:
Experimental data from the SX3 prototype data at the University of Stuttgart are used to extrapolate the heat generation at the anode. The SX3 prototype is discuss in A. Boxberger and G. Herdrich, “Integral Measurements of 100 kW Class Steady State Applied-Field Magnetoplasmadynamic Thruster SX3 and Perspectives of AF-MPD Technology,” in 35th International Electric Propulsion Conference, Atlanta, 2017.
The increase of the anode heating with the magnetic field is linear according to the experimental investigations published by Dan Lev and Edgar Y. Choueiri, Scaling of Anode Sheath Voltage Fall with the Operational Parameters in Applied-Field MPD Thrusters, 32nd International Electric Propulsion Conference, (2011), Wiesbaden, Germany, IEPC-2011-222.
The most demanding conditions for the anode will be for the maximum discharge current, which for the current hollow cathode technology is 180 A (and therefore the highest currents operating the thruster).

Radiation cooling is used to cool the anode. The anode's design needs to be such that the thermal radiation to the environment is sufficient that the heat load on the anode do not cause the temperature of the anode to increase beyond the operation temperature of the anode. It will be appreciated that a greater surface area of the anode will enable a greater degree of radiation, but this greater surface area comes at a cost of increased weight. An energy balance needs to be developed between the generated heat and the thermal radiation to the environment.

The radiation-cooled anode dissipates the energy by thermal radiation according to the following equation:

Q_{rad}=εσT⁴

where ε is the total hemispherical emissivity of the material and T is the operational temperature of the anode surface. The value of σ is Stefan-Boltzmann constant σ=5.670374419 . . . ×10−8 W·m⁻²·K.

The heat generated by the electric discharge proposed by V. B. Tikhonov and S. A. Semenkin, Performance of 130 kW MPD Thruster with an external magnetic field and Lithium as a propellant, IEPC 97-117, 1997 and can be written as

Qₐ=UₐJ+ϕₐJ+52kTeeJ+_{Qconv+rad}

where Uₐ is the anode fall voltage, ϕₐ the material surface work function, 52kTee is the heat deposited by the high temperature electrons and Q_{conv+rad} is the plasma convection and radiation contribution, being the latter relatively low in comparison to the first two (about 3% of the total electric power for the Hot Anode Thruster (HAT) developed at the University of Stuttgart.

Taking the anode power losses of the Stuttgart SX3 conditions before the onset phenomena as reference, see FIG. 5, a simplified scaling law for the anode losses with respect to the current and ignoring the other effects such as the B-field can be written as

Qₐ=AJ

where A=0.0508 kW/A or [kV] is the scaling factor and J is the discharge current.

Operating the thruster of this document at currents up to 180 A, the expected anode losses would be about Qₐ(0.4 T)=9.1 kW. Applying the same extrapolation for the anode power losses in the HAT, Qₐ(0 T)=1.5 kW. Thus, the increase of power losses due to the magnetic field can be approximated to:

Qₐ=(A(0.4T)=9.1kW

where A₁=0.0083 V and A₂=0.1056 V/T

Assuming that the outer conical segment of the anode is a disk the surface area that is emitting to a cold environment can be written as

S_{rad}=π(R²ₐₑ−R²ₐᵢ)

where Rₐᵢ and Rₐₑ are the inner and outer radius of the disk. The smallest inner radius is defined by the hollow cathode radius and the HC outer radius is 13 mm considering the design from Coletti published in Coletti, M., “Simple Thrust Formula for an MPD Thruster with Applied-Magnetic Field from Magnetic Stress Tensor,” 43rd AIAA/ASME/SAE/ASEE Joint Propulsion Conference & Exhibit, Cincinnati, Ohio, 2007.

An approximation of the anode temperature for a maximum operation at 180 A assuming that the heat conduction on the disk is very high and the temperature of the surface along the disk is constant. Thus, the temperature (T) of the anode can be calculated using the following equation:

T=(Qₐ/εσS_{rad})^{1/4}

The maximum operational temperatures for different anode geometries at arc currents up to 180 A and an applied magnetic field of 0.4 T (top) and 1 T (bottom) are shown in FIG. 7 together with the maximum operational temperatures of different molybdenum alloys. Dashed lines indicate the maximum operational temperatures of different Molybdenum alloys.

A more accurate calculation of the maximum operational temperature requires the creation of a CAD and FEM model of the anode 30. This model includes the material thermal properties and the thermal boundary conditions in order to calculate a temperature distribution along the anode geometry. In addition, it will be necessary to improve the anode heat production model including the effect of mass flow rate.

### REFERENCE NUMERALS

10 Magnetoplasmadynamic thruster
15 Central axis
20 Cathode
25 Thermionic insert
30 Anode
40 Volume
50 Propellant
60 Injection point
70 Plasma
75 Plasma plume
100 First superconducting magnet system/acceleration coil system
110 Second superconducting magnet system/vectoring coil system
112 End
115 Nozzle
120 First superconducting coils
125 Second superconducting coils
130 Cryostat
140 Thermal management system
150 Coil loading connection
200 Superconducting magnet
210 Superconducting coil
220 Superconducting coil
300 Thruster

1. A propulsion unit for a spacecraft comprising:
a centrally arranged cathode;
a concentric anode;
an injection point for injecting a propellant (50) between the central cathode (20) and the concentric anode;
an acceleration coil system;
a vectoring coil system for expelling a plasma plume from a nozzle; and
a plurality of superconducting coils arranged about the concentric anode for creating a magnetic field between the central cathode and the concentric anode (30) and directing the plasma plume from the nozzle.

2. The propulsion unit of claim 1, further comprising a thermal management system arranged between at least part of the concentric anode and the plurality of superconducting coils.

3. The propulsion unit (10) of claim 1, further comprising a cryostat for cooling the superconducting coils.

4. The propulsion unit of claim 1, wherein at least some of the plurality of superconducting coils are arranged in one of a triple helix or a double helix manner about the concentric anode.

5. The propulsion unit of claim 1, wherein the centrally arranged cathode further includes a thermionic insert.

6. The propulsion unit of claim 1, further comprising a connection for loading the superconducting coils with an electric current.

7. The propulsion unit of claim 6, wherein the connection is an inductive loading connection.

8. A method of propelling a spacecraft comprising:
generating a plasma in a volume between a centrally arranged cathode (20) and a concentric anode;
generating a first magnetic field from a first superconducting magnet system in the volume to accelerate ions in the plasma and create a plasma plume;
generating a second magnetic field in the second superconducting magnet system, thereby causing the plasma plume to be directed in a movement direction.
